(19) United States
(12) Patent Application Publication
(10) Pub. No.: US 2012/0011951 A1
(43) Pub. Date: Jan. 19, 2012

(54) LINEAR ACTUATOR

(75) Inventor: Jean-Pierre Gaecther, Rebigue (FR)

(73) Assignee: PRECILEC, AUXERRE (FR)

(21) Appl. No.: 13/131,157

(22) PCT Filed: Nov. 24, 2009
(86) PCT No.: PCT/FR2009/052276

§ 371 Date: Jul. 19, 2011

(30) Foreign Application Priority Data
Nov. 25, 2008 (FR) 0858000

(51) Int. Cl. F16H 25/12

(52) U.S. Cl. 74/89.23

(57) ABSTRACT

The invention relates to a linear actuator comprising: —an outer tubular body having a helical rolling track; —an internal tubular body with an engine rotatable around a shaft that is coaxial to the tubular bodies; —at least one nut having at least one helical rolling path and a reflow area mounted on said shaft; —and ball bearings placed between a rolling path of at least one nut and a rolling track of the outer tubular body, as well as in the reflow area of such a nut. Said actuator is characterized in that it comprises at least one means for bearing against a rolling track of the outer tubular body along at least one line of contact, and at least one means for controlling said bearing means.

The subject of the present invention is a linear actuator having a ball screw making it possible to convert a rotational movement into a translational movement.

This invention relates to the field of the manufacture of mechanical linear actuators and more particularly those designed to perform an actuation in response to an impulse from an electric motor (electromechanical actuator).

Such an electromechanical actuator is already known which makes it possible to overcome the disadvantages of hydraulic or pneumatic actuators, which usually consist of rams, that require an external fluid source, are difficult to control and lack accuracy.

Such an electromechanical actuator generally has a ball screw/nut system as well as an electric motor designed to drive said nut in rotation, which rotation drives the screw in translation.

In particular, the document EP-1,523,630 discloses an electromechanical actuator having an outer tubular body provided internally with at least one helical rolling track intended to guide balls which this actuator comprises and giving this outer tubular body the structure of a screw.

This actuator also has an inner tubular body which can move in translation inside the outer tubular body and has internally an electric motor for driving in rotation a shaft coaxial with the two tubular bodies.

The actuator also has a nut which can move in translation and in rotation inside the tubular body and is mounted so as to be fixed in rotation on said shaft so that it can be driven in rotation by the latter, in response to an impulse from the motor. This nut has, on the one hand, a helical rolling path which extends around this nut and is provided with two ends and, on the other hand, a recirculation zone joining the two ends of this rolling path. In fact, such a nut consists of a plurality of aligned elements which are cylindrical in shape and each have at least one bevel. The bevels of two immediately juxtaposed elements define a rolling path for the balls of the actuator.

This advantageous design of such an actuator makes it possible to benefit from a circulation diameter of the center of the balls which is greater than that of the conventional actuators, and to have recourse to balls with a diameter which is also greater. This contributes to a significant reduction of the Hertz stress applied at different points by these balls to the rolling track for the same actuating force as that exerted in the case of a conventional actuator. As a result, the outer tubular body is subjected, during normal operation of the actuator, to reduced stresses, which advantageously makes it possible to produce such a body from plastic, in particular by molding.

However, such an actuator has disadvantages when it is subjected to static stresses which are greater than the dynamic stresses exerted during normal actuating operation by the actuator and resulting in particular from an impact to which this actuator is subjected. Indeed, under the effect of such a static stress, the balls tend to bear strongly against the rolling track and cause damage to it.

The object of the present invention is to overcome the disadvantages of actuators from the prior art.

To this end, the invention relates to a linear actuator having:
an outer tubular body extending along an axis and having internally at least one helical rolling track;
an inner tubular body which can move in translation inside the outer tubular body, coaxial thereto, and accommodating internally a motor for driving in rotation a shaft which is coaxial with the tubular bodies;
at least one nut which is mounted on this shaft and can move in rotation and in translation inside the outer tubular body and has, on the one hand, at least one helical rolling path which extends around this nut and is provided with two ends and, on the other hand, a recirculation zone joining the two ends of such a rolling path;
balls arranged between a rolling path of at least one nut and a rolling track of the outer tubular body, and in the recirculation zone of such a nut.

According to the invention, this actuator has:
at least one bearing means which, on the one hand, consists of a pad with a cylindrical general shape made integral with and fixed to the shaft and having at least one helical thread extending around this pad and, on the other hand, is designed so as to bear against a rolling track of the outer tubular body along at least one line of contact;
at least one control means for this bearing means, this control means having, on the one hand, a means for mounting the nut or nuts on the shaft so as to be fixed in rotation and movable in translation and, on the other hand, axially and on either side of such a nut, at least one means for exerting a prestress on such a nut, this control means being designed, on the one hand, to hold such a bearing means in an inactive bearing position in which there is a clearance between this bearing means and the rolling track and, on the other hand, to cause such a bearing means to take up an active bearing position on the rolling track, this taking place under the effect of an axial stress, greater than a threshold stress, exerted on the actuator.

An additional feature relates to the fact that the means for exerting a prestress consists of an elastic element crushed by a value corresponding to the threshold stress.

Lastly, another feature consists in that the nut or nuts of this actuator have at least two cams:
with a cylindrical general shape;
axially aligned;
and each having at least one bevel with an adapted shape and produced so as to define a helical rolling path around this nut and a machined portion produced so as to define a recirculation zone for the balls.

The actuator according to the present invention has a means designed so as to bear against a rolling track of the outer tubular body and does so along at least one line of contact. A bearing of this type advantageously makes it possible to distribute the stresses exerted on such a rolling track in accordance with a line of contact and no longer to limit the application of these stresses to individual zones corresponding to the point of contact of a ball with this rolling track.

Another advantage consists in that the actuator has a control means which ensures that this bearing means is held in an inactive position in which this bearing means does not bear against the rolling track and thus does not hinder the actuation, this taking place when this actuator is at rest and as part of the normal operation of the actuator but also when an axial stress below a threshold stress is exerted on this actuator.

In contrast, this control means is designed to cause the bearing means to take up an active position bearing against the rolling track, this taking place only when an axial stress above a threshold value is exerted on this actuator. Such a stress corresponds, for example, to a static stress exerted on the actuator and resulting, in particular, from an impact to which this actuator has been subjected, by the movable element actuated by this actuator or by the fixed element associated with this actuator.

Another advantage consists in that this bearing means and this control means consist of elements which have a simple design and allow easy intervention, in particular with a view to installing, checking or replacing them.

Other objects and advantages of the present invention will become apparent in the course of the following description with reference to embodiments which are given purely by way of indicative example and with no limitation implied.

Understanding of this description will be facilitated with reference to the attached drawings, in which:

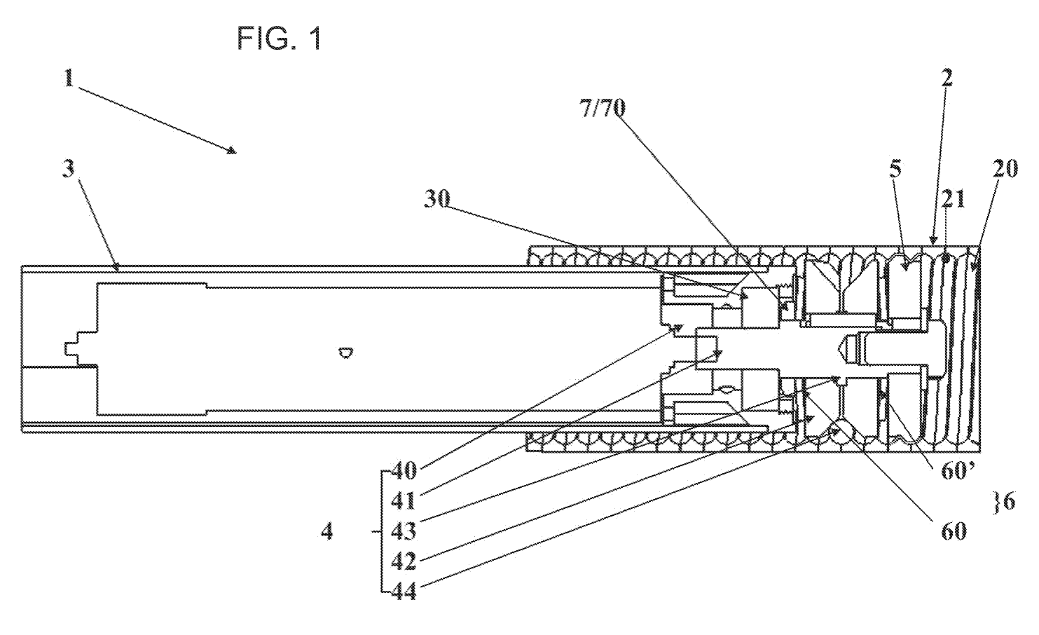

FIG. 1 is a general view and in cross section of an actuator according to the present invention;

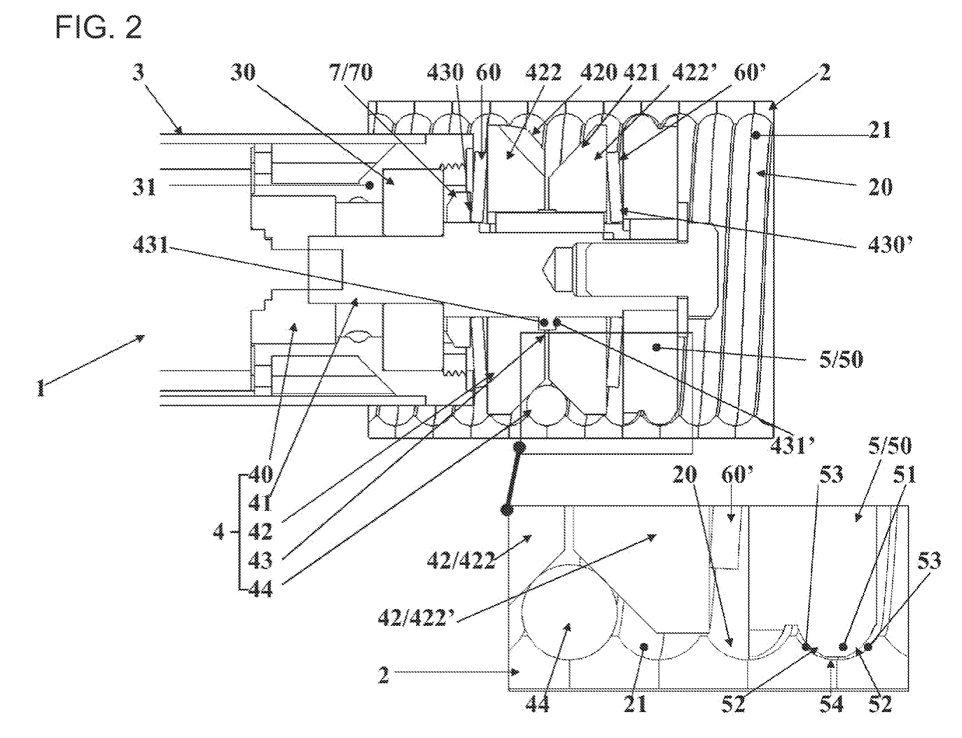

FIG. 2 is a diagrammatic detailed view of the actuator illustrated in FIG. 1 and showing the nut, the bearing means and a first embodiment of the control means, this taking place in the inactive bearing position of the bearing means;

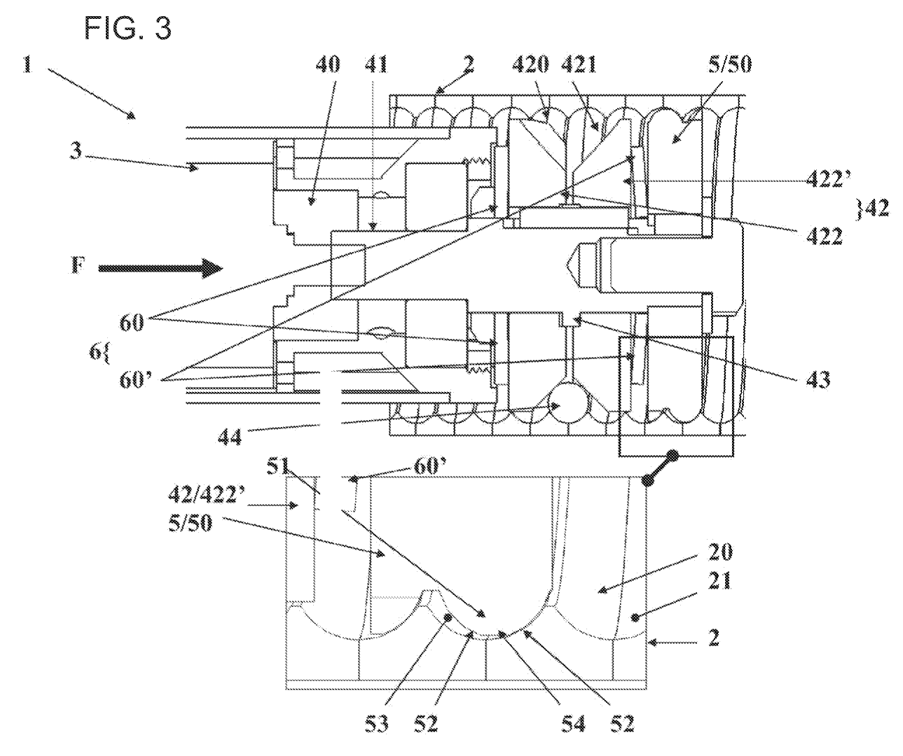

FIG. 3 is a view similar to the preceding one and corresponds to the control means and to the bearing means adopting an active bearing position of the bearing means;

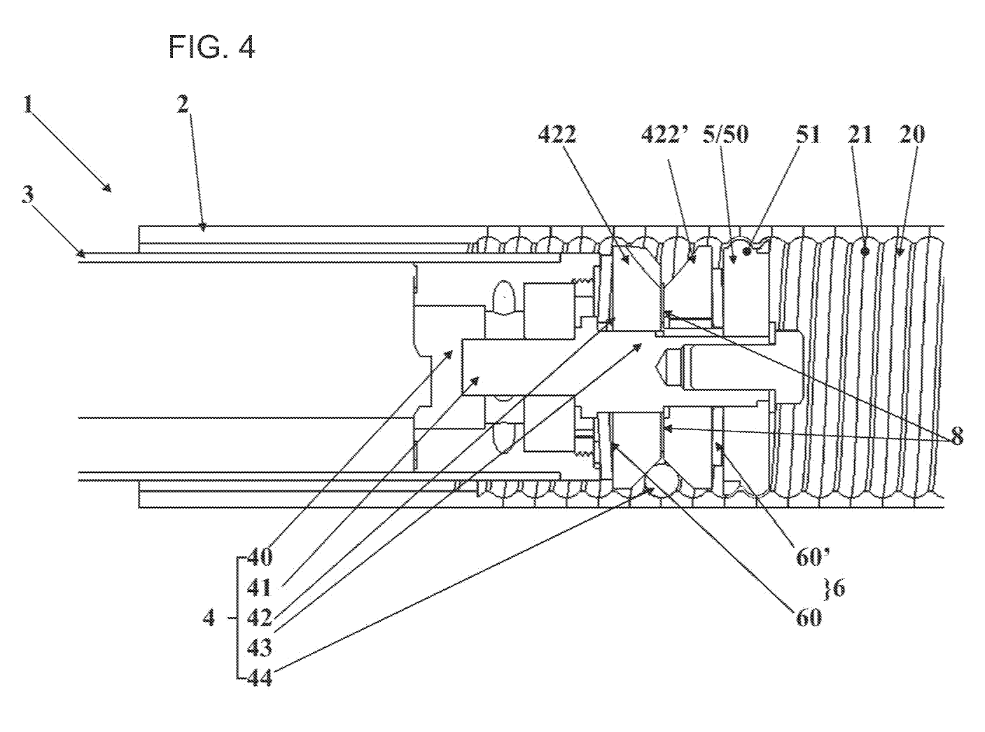

FIG. 4 is a diagrammatic detailed view of an actuator and showing the nut, the bearing means and a second embodiment of the control means, this taking place in the inactive bearing position of the bearing means;

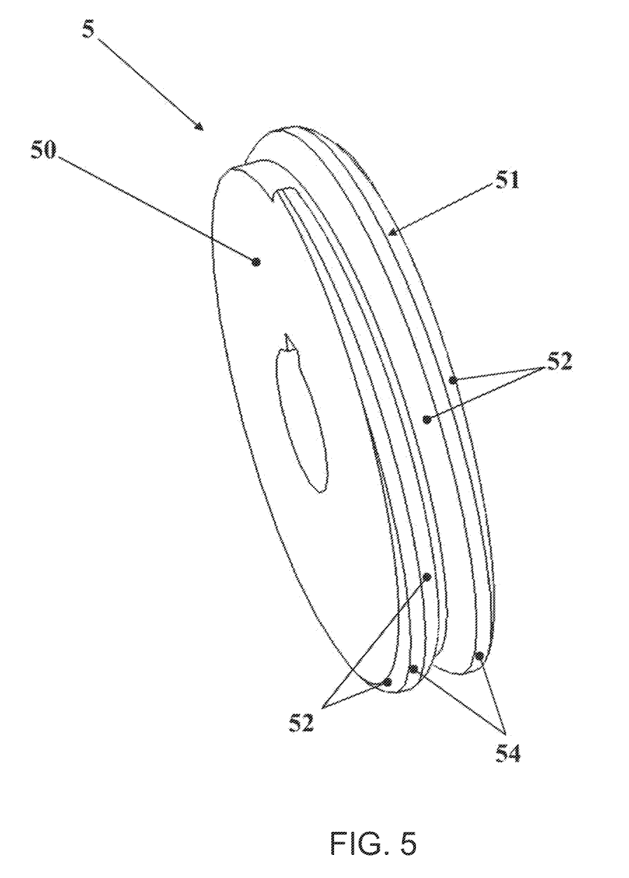

FIG. 5 is a diagrammatic perspective view of a bearing means according to the invention.

The present invention relates to the field of the manufacture of mechanical linear actuators which have a ball screw making it possible to convert a rotational movement into a translational movement.

Such an actuator 1 has an outer tubular body 2 extending along an axis and having internally at least one helical rolling track 20 defined at the inner wall 21 of this outer tubular body 2.

In fact, such a rolling track 20 can be produced by deforming this inner wall 21 or by molding during the process of manufacturing the tubular body 2. Another embodiment consists in that this rolling track 20 can be defined by at least one helical thread (more particularly made from high-strength steel) positioned inside the outer tubular body 2, against the inner wall 21 of the latter 2.

This actuator 1 also has an inner tubular body 3 and it too extends along an axis which preferably corresponds to the axis of the outer tubular body 2 such that these tubular bodies (2; 3) are coaxial.

In fact, this inner tubular body 3 extends, at least partially, inside the outer tubular body 2. The actuator 1 is designed such that these tubular bodies (2; 3) are fixed in rotation but can move in translation so as to allow the inner tubular body 3 to slide relative to the outer tubular body 2 and inside the latter 2, this taking place in the longitudinal direction of these tubular bodies (2; 3).

The actuator 1 also has a means 4 designed to drive in sliding motion these tubular bodies (2; 3) one 2 relative to the other 3.

Such a drive means 4 has, on the one hand, an electric motor 40 with a stator which is mounted fixedly to the inside of the inner tubular body 3.

On the other hand, this drive means 4 has a drive shaft 41, integral in rotation with the rotor of the electric motor 40 (either directly or via a reducing gear), to drive it in rotation and extending in an axis corresponding preferably to the axis of the tubular bodies (2; 3).

This drive shaft 41 extends at least partially inside the inner tubular body 3 in which 3 it is guided via at least one bearing 30, in particular a ball bearing, which this inner tubular body 3 has on the inside and the inner ring of which is mounted fixed in rotation on the shaft 41, whilst the outer ring is mounted fixed in rotation inside the inner tubular body 3, in particular on the inner wall 31 of the latter 3.

As can be seen in the attached figures, this drive shaft 41 also extends outside this inner tubular body 3 as well as inside the outer tubular body 2 of the actuator 1.

The drive means 4 also has at least one nut 42 which has, on the one hand, at least one helical rolling path 420 which extends around this nut 42 and is provided with two ends and, on the other hand, a recirculation zone 421 joining the two ends of such a rolling path 420.

Furthermore, this drive means 4 has a means 43 for mounting such a nut 42 on the drive shaft 41 so as to be fixed in rotation. This mounting means 43 then allows such a nut 42 to be mounted so as to be able to move both in rotation and in translation inside the outer tubular body 2.

Lastly, this drive means 4 has a plurality of balls 44 arranged between a helical rolling path 420 of at least one nut 42 and a rolling track 20 of the outer tubular body 2, and in the recirculation zone 421 of such a nut 42.

This drive means 4 is then designed so that the electric motor 40 drives the drive shaft 41 in rotation, which itself drives in rotation at least one nut 42. Such a nut 42, under the effect of its rotation, drives the balls 44 which are displaced inside the helical rolling path 420 of this nut 42 as well as inside the rolling track 20 of the outer tubular body 2, thus causing the inner tubular body 3 to slide relative to this outer tubular body 2.

According to the invention, this actuator 1 has at least one means 5, associated with the shaft 41 and designed so as to bear against a rolling track 20 of the outer tubular body 2 along at least one line of contact.

In this respect and as can be seen in the attached figures, this bearing means 5 takes the form of a generally cylindrical pad 50 which extends along an axis which preferably corresponds to the axis of the tubular bodies (2; 3).

Such a pad 50 is made integral with and fixed to (in rotation and in translation) the drive shaft 41, more particularly with the free end of this shaft 41, at the opposite end from that which engages with the electric motor 40.

Another feature of this pad 50 consists in that it has at least one helical thread 51 which extends around this pad 50, more particularly at the edge of this pad 50.

This helical thread 51 has a pitch which is substantially equal to the pitch of the helical rolling track 20 of the outer tubular body 2.

As can be seen in the attached figures, this helical thread 51 has a profile which largely adopts a general semi-circular shape with a radius substantially equal to that of the balls 44.

More precisely, this helical thread 51 in fact has a profile which adopts the shape of two arcs of a circle 52, the centers of which are preferably offset and the radii of which substantially correspond to that of the balls 44.

In this respect, it will be observed that the centers of the circles of these two arcs of a circle 52 are offset axially, more particularly in accordance with an axis parallel to the axis of the outer tubular body 2 and/or passing through the center of a ball 44 rolling on the rolling track 20 of this outer tubular body 2.

In fact, the offset between the centers of the circles of the two arcs of a circle 52 substantially corresponds to a lateral clearance 53 defined between the thread 51 of the pad 50 and the rolling track 20 of the outer tubular body 2.

It is more particularly those portions of the thread 51 of the pad 50 which are delimited by these two arcs of a circle 52 that can come to bear against the rolling track 20 of the outer tubular body 2 (more particularly against the sides of this track 20) and do so along at least one line of contact.

In this respect, it should be observed that this rolling track 20 has a profile which adopts the shape of a semi-circle with a radius that substantially corresponds to that of the balls 44 which roll on this track 20. The profile of this rolling track 20 then also corresponds to the profile of the two arcs of a circle 52 of the helical thread 51 of the pad 50 such that this pad 50 can bear against this rolling track 20 along a line of contact having a certain width and which in fact more particularly is akin to a contact strip with a width substantially corresponding to the length of such an arc of a circle 52.

Another feature of the helical thread 51 of the pad 50 consists in that the apex 54 of this thread 51 has at least one truncated portion so as to prevent contact of this apex 54 with the rolling track 20 (more particularly with the base of the rolling track 20) of the outer tubular body 2.

In terms of the bearing of the bearing means 5 against the rolling track 20 of the outer tubular body 2, it in fact results from an external stress exerted on the actuator 1 (in particular on the outer tubular body 2 and/or on the inner tubular body 3 of this actuator 1). Such an external stress corresponds to an accidental stress (other than a stress exerted on this actuator 1 as part of its normal actuating operation) consisting more particularly of a static stress, resulting in particular from an impact to which this actuator 1 is subjected.

In this respect, it will be observed that such an external stress has an axial component F which extends in accordance with the axis of extension of the tubular bodies (2; 3) and of the drive shaft 41.

According to the invention, the actuator 1 also has at least one means for controlling 6 the abovementioned bearing means 5.

This control means 6 is designed so as to cause such a bearing means 5 to take up an active position bearing against the rolling track 20 (along at least one line of contact as described above), this taking place under the effect of an axial stress F, greater than a threshold stress Fs, exerted on the actuator 1 (FIG. 3).

This control means 6 is also designed to hold such a bearing means 5 in an inactive bearing position in which there is a clearance 53 (on each side of the thread 51) between this bearing means 5 and the rolling track 20, this taking place in the absence of any stress or for an axial stress F less than said threshold stress Fs (FIGS. 2 and 4).

As mentioned above, the drive means 4 has a means 43 for mounting at least one nut 42 on the drive shaft 41.

In fact and according to a particular feature of the invention, the control means 6 of the bearing means 5 consists at least partially of this mounting means 43 which is, according to the invention, designed to ensure the mounting of the nut or nuts 42 on the shaft 41 so as to be fixed in rotation and movable in translation.

In this respect, it will be observed that, in order to effect such a type of mounting, this mounting means 43 has, by way of example, at least one key designed so as to interact with a groove formed at least on a nut 42 or also on the shaft 41 as well as on the bearing means 5 (FIG. 5).

Another feature consists in that such a means 43 for mounting a nut 42 has lateral stops (430, 430′) between which such a nut 42 is mounted in translation.

In fact and as can be seen in the attached figures, at least one such lateral stop 430 can consist of a shoulder associated with the drive shaft 41. Such a shoulder can then be defined at the body of the shaft 41 or alternatively be defined at a clamping nut 70 (described in more detail below) mounted axially on this shaft 41.

Moreover, one of these lateral stops 430′ can consist of the abovementioned bearing means 5.

A preferred embodiment of the invention is shown in the attached figures, corresponding to an actuator 1 having a single nut 42 mounted on the shaft 41 so as to be capable of translational movement between two lateral stops (430, 430′). In this embodiment, one 430′ of these lateral stops then consists of the bearing means 5, whilst the other 430 consists of a nut 7 associated with the shaft 41.

An additional feature of the invention consists in that the control means 6 also has, on either side of at least one nut 42, at least one means (60; 60′) for exerting a prestress on such a nut 42.

In fact, such a prestressing means (60; 60′) is positioned axially and more particularly in accordance with the axis of the outer 2 and inner 3 tubular bodies, relative to the drive shaft 41.

According to a preferred embodiment of the invention illustrated in the attached figures, such a means (60; 60′) for exerting a prestress is placed between a lateral stop (430; 430′) and a nut 42 of the actuator 1. It is more particularly against such a lateral stop (430; 430′) and against such a nut 42 that such a prestressing means (60; 60′) bears, and does so in order to exert such a prestress on such a nut 42.

In fact, a preferred embodiment consists in that a means 60 for exerting a prestress consists of an elastic element crushed by a value corresponding to the threshold stress Fs.

Such an elastic element can consist of a spring (more particularly a helical spring) or even (and preferably) of a Belleville washer.

Thus, when the stress exerted on the actuator 1 is less than the threshold stress Fs, the shaft 41 and the nut 42 take up an inactive bearing position (FIGS. 2 and 4).

However, when the stress exerted on the actuator 1 exceeds the threshold stress Fs, the shaft 41 will be offset slightly relative to the nut 42 bearing against the balls 44 until the excess stress (relative to the threshold stress Fs) compresses the prestressing means 60 by the value of the clearance 53 between the bearing means 5 and the rolling track 20.

The bearing means 5 then bears against the rolling track 20 which receives the force (FIG. 3). This bearing contact is effected along at least one line of contact which represents a contact surface area which is considerably larger than that of the contact points of the balls 44 with the rolling track 20.

Moreover, these balls 44 are subjected only to a force limited by the threshold stress Fs plus the delta of force required to ensure the displacement of the shaft 41 with a view to the bearing means 5 bearing against the rolling track 20. The Hertz pressure resulting from the points of contact between the balls 44 and the rolling track 20 is then limited, particularly in comparison with the pressure exerted by the bearing means 5 against this rolling track 20.

The majority of the stress to which the actuator 1 is subjected is then exerted at least on the line of contact between the bearing means 5 and the rolling track 20, which allows a better distribution of this stress on the actuator 1 (compared with a same stress exerted solely through points of contact as is the case for actuators from the prior art) and consequently makes it possible to limit (or even prevent) damage which may be caused to this actuator 1 by such a stress.

An additional feature consists in that the actuator 1 according to the invention has a means 7 for adjusting the prestress exerted by a prestressing means (60; 60′) on at least one nut 42. Such an adjusting means 7 has a clamping nut 70 associated with the drive shaft 41 (in particular mounted axially on the latter 41), defining a shoulder forming an abovementioned lateral stop 430 and bearing against such a prestressing means 60.

Another feature of the invention consists in that the nut or nuts 42 of the drive means 4 has features which have been described in more detail in the document EP-1,523,630.

In fact, such a nut 42 has at least two cams (422, 422′) which adopt a cylindrical general shape and each extend along an axis which preferably corresponds to the axis of the tubular bodies (2; 3).

As can be seen in the attached figures, these cams (422, 422′) are aligned axially with such an axis and are positioned one 422 opposite the other 422′.

These cams (422; 422′) each have at least one bevel with an adapted shape and produced so as to define a helical rolling path 420 around the nut 42 formed by these cams (420; 420′).

The cams (422; 422′) also each have a machined portion produced so as to define a recirculation zone 421 for the balls 44.

A particular embodiment consists in that the nut 42 of an actuator 1 has in fact two cams (422; 422′) which have a symmetrical or even (and preferably) identical structure.

An additional feature of the invention consists in that the actuator 1 (more particularly its mounting means 43) has a plurality of detent stops (431; 431′) each associated with a cam (422; 422′) of the nut 42. It is more particularly against such a detent stop (431; 431′) that such a cam (422; 422′) is held in bearing contact by a means (60; 60′) for exerting a prestress.

FIGS. 1 to 3 thus show a first embodiment of the invention (which constitutes more particularly a symmetrical solution) in which such a detent stop (431; 431′) consists of a shoulder defined at the body of the shaft 41 and against which a cam (422; 422′) is held in bearing contact.

In fact, such holding is ensured for an axial stress, exerted on the prestressing means (60; 60′) associated with this cam (422; 422′), which is less than or equal to the threshold stress Fs. In particular and as can be seen in FIGS. 1 and 2, such holding is ensured when there is no stress exerted on such a prestressing means (60; 60′).

As can be seen in the attached FIGS. 1 to 3, the detent stops (431; 431′) associated with the cams (422; 422′) of a same nut 42 are placed between two cams (422; 422′) of this nut 42, or even consist of a single element (more particularly consist of a radial groove) in which two shoulders forming such detent stops (431; 431′) are defined.

FIG. 4 shows a second embodiment (which constitutes more particularly a differential solution) in which a detent stop (431; 431′) associated with a cam (422; 422′) of a nut 42 in fact consists of another cam (422′; 422) which this nut 42 has and against which (422′; 422) this cam (422; 422′) is held in bearing contact.

Here too, such holding is ensured for an axial stress exerted on the prestressing means (60; 60′) associated with this cam (422; 422′) which is less than or equal to the threshold stress Fs. In particular and as can be seen in FIG. 4, such holding is ensured when there is no stress exerted on such a prestressing means (60; 60′).

In fact, each cam (422; 422′) of a same nut 42 can bear against the other cam (422′; 422) of this nut 42, this taking place directly or indirectly.

In this respect and as can be seen in FIG. 4, the actuator 1 according to the invention can have, placed between two cams (422; 422′) of a same nut 42, an intermediate element 8 against which bears each of these two cams (422; 422′), in particular in response to an impulse from the means (60; 60′) for exerting a prestress on this nut 42, this effecting an indirect bearing of one such cam (422; 422′) against the other (422′; 422).

An additional feature of the invention consists in that the actuator 1 also has a means 8 for adjusting a prestress exerted by these cams (422; 422′) on the balls 44.

In fact, such an adjustment means 8 is more particularly designed so as to exert a basic prestress on these balls 42 via these cams (422; 422′).

A preferred embodiment consists in that this adjustment means 8 is placed between two cams (422; 422′) of a same nut and more particularly consists of the abovementioned intermediate element 8.

According to a preferred embodiment, this adjustment means 8 can consist of a washer engaged on the drive shaft 41.

Particularly, this adjustment means 8 can advantageously be designed so as to always exert the same prestress on the balls 42, and do so even in the event of wear. To this end, this adjustment means 8 can be of a resilient type and then consist of a resilient washer.

Lastly, as part of this second embodiment (differential solution) and as can be seen in FIG. 4, the drive shaft 41 receiving the cams (422; 422′) of at least one nut 42 is preferably of the stepped type.

A drive shaft 41 of this type then advantageously allows easy mounting (and demounting) of the various elements which constitute the drive means 4, the bearing means 5 and the control means 6, on the inner tubular body 3.

1-14. (canceled)

15. A linear actuator having:
an outer tubular body extending along an axis and having internally at least one helical rolling track;
an inner tubular body which can move in translation inside the outer tubular body, coaxial thereto, and accommodating internally a motor for driving in rotation a shaft which is coaxial with the tubular bodies;
at least one nut which is mounted on this shaft and can move in rotation and in translation inside the outer tubular body and has, on the one hand, at least one helical rolling path which extends around this nut and is provided with two ends and, on the other hand, a recirculation zone joining the two ends of such a rolling path;
balls arranged between a rolling path of at least one nut and a rolling track of the outer tubular body, and in the recirculation zone of such a nut, characterized in that the actuator has:
at least one bearing means which, on the one hand, consists of a pad with a cylindrical general shape made integral with and fixed to the shaft and having at least one helical thread extending around this pad and, on the other hand, is designed so as to bear against a rolling track of the outer tubular body along at least one line of contact;
at least one control means for this bearing means, this control means having, on the one hand, a means for mounting the nut or nuts on the shaft so as to be fixed in rotation and movable in translation and, on the other hand, axially and on either side of such a nut, at least one means for exerting a prestress on such a nut, this control means being designed, on the one hand, to hold such a bearing means in an inactive bearing position in which there is a clearance between this bearing means and the rolling track and, on the other hand, to cause such a bearing means to take up an active bearing position on the rolling track, this taking place under the effect of an axial stress, greater than a threshold stress, exerted on the actuator.

16. The linear actuator as claimed in claim 15, characterized in that the helical thread has a pitch which is substantially equal to that of the helical rolling track of the outer tubular body.

17. The linear actuator as claimed in claim 15, characterized in that the helical thread has a profile which largely adopts a general semi-circular shape with a radius substantially equal to that of the balls.

18. The linear actuator as claimed in claim 15, characterized in that the helical thread has a profile which adopts the shape of two arcs of a circle, the centers of which are offset and the radii of which substantially correspond to that of the balls.

19. The linear actuator as claimed in claim 18, characterized in that the offset between the centers of the circles of the two arcs of a circle substantially corresponds to a lateral clearance between the thread of the pad and the rolling track of the outer tubular body.

20. The linear actuator as claimed in claim 15, characterized in that the apex of the thread has at least one truncated portion so as to prevent contact of this apex with the rolling track of the outer tubular body.

21. The linear actuator as claimed in claim 15, characterized in that the means for mounting a nut has lateral stops between which such a nut is mounted in translation, and in that a means for exerting a prestress is placed between such a lateral stop and the nut.

22. The linear actuator as claimed in claim 15, characterized in that the means for exerting a prestress consists of an elastic element crushed by a value corresponding to the threshold stress.

23. The linear actuator as claimed in claim 15, characterized in that the nut or nuts have at least two cams with a cylindrical general shape, axially aligned, and each having at least one bevel produced so as to define a helical rolling path around this nut and a machined portion produced so as to define a recirculation zone for the balls.

24. The linear actuator as claimed in claim 23, characterized in that the actuator has a plurality of detent stops each associated with a cam of the nut, and in that each cam is held in bearing contact against such a detent stop by a means for exerting a prestress.

25. The linear actuator as claimed in claim 24, characterized in that the detent stop consists of a shoulder defined at the body of the shaft and against which a cam is held in bearing contact, this taking place for an axial stress, exerted on the prestressing means associated with this cam, which is less than or equal to the threshold stress.

26. The linear actuator as claimed in claim 24, characterized in that the detent stop associated with a cam of a nut consists of another cam which this nut has and against which this cam is held in bearing contact, this taking place for an axial stress, exerted on the prestressing means associated with this cam, which is less than or equal to the threshold stress.

27. The linear actuator as claimed in claim 26, characterized in that the actuator has, placed between two cams of a same nut, a means for adjusting a prestress exerted by these cams on the balls.

28. The linear actuator as claimed in claim 26, characterized in that the shaft receiving the cams of at least one nut is of the stepped type.
